(19) United States
(12) Patent Application Publication
(10) Pub. No.: US 2026/0195225 A1
(43) Pub. Date: Jul. 9, 2026

(54) COMPUTER SYSTEM FOR TESTING SERVERS

(71) Applicant: Aivres Systems Inc., San Jose, CA (US)

(72) Inventor: Yatzu HUANG, New Taipei City (TW)

(21) Appl. No.: 19/012,262

(22) Filed: Jan. 7, 2025

(51) Int. Cl. G06F 11/263; G06F 11/22

(52) U.S. Cl. CPC G06F 11/263; G06F 11/2263

(57) ABSTRACT

A method for testing servers includes: constructing an artificial intelligence (AI) framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database. In some embodiments, the method further includes constructing a user interface for receiving the test task.

### TECHNICAL FIELD

This disclosure is generally related to a computer system, and more particularly to an artificial intelligence computer system for testing servers.

### BACKGROUND

The traditional testing interface for testing server computers (servers) is increasingly difficult to maintain due to inconsistencies in the testing environment. The test execution relies heavily on detailed documentation, which can complicate the test process. Furthermore, it lacks remote collaboration and sharing capabilities, making it challenging to directly access local testing projects, which in turn reduces collaboration efficiency.

Additionally, test results require manual management, leading to potential loss, confusion, or difficulty in tracking outcomes. This manual approach consumes developers' time and energy.

The traditional testing methods are plagued by challenges in test management, collaboration, and sharing, among other shortcomings.

### SUMMARY

The disclosed techniques provide a method and system for enhancing automation test interfaces. This may be achieved by introducing a novel algorithm that enables high-performance and stable automation testing.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, a method for testing servers is provided. The method includes constructing an artificial intelligence (AI) framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database. In some embodiments, the method further includes constructing a user interface for receiving the test task.

In some embodiments, constructing AI framework system may include: creating a system file defining an AI environment for an AI framework to run; adding, to the AI framework, libraries and algorithms that support fuzzy logic and machine learning; and building a system image by incorporating fuzzy logic algorithms and machine learning models defined in the AI framework.

In some embodiments, the method further includes: initializing the AI environment by setting an initial state of automation processes and creating agents for learning; observing current state of the AI environment by collecting data and converting features from the data into numerical values; and setting up the machine learning models and fuzzy rules for the fuzzy logic algorithms based on the numerical values.

In some embodiments, observing current state of the AI environment by collecting data and converting features from the data into numerical values may include collecting test parameters based on each test execution in the AI environment; selecting features that are highly correlated with a test execution time of each test execution; and converting the features into numerical features or applying standardization to the features.

In some embodiments, the test parameters comprise one or more of a type of each test, a number of test cycles, configurations of the servers, and a test time of each test.

In some embodiments, setting up the machine learning models and fuzzy rules for the fuzzy logic algorithms based on the numerical values may include: combining a fuzzy logic system with a multi-layered neural network to set up the machine learning models and the fuzzy rules.

In another general aspect, a computer system is provided. The computer system includes one or more processors and one or more memories storing computer instructions. The one or more processors are configured to execute the computer instructions to perform operations including: constructing an AI framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database.

In another general aspect, a non-transitory computer-readable storage medium is provided. The non-transitory computer-readable storage medium is configured to store computer instructions which, when executed by one or more processors, cause the one or more processors to perform operations including: constructing an AI framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 is a flow chart illustrating a method for testing servers, according to one example embodiment.

FIG. 2 is a flow chart illustrating operation 102 as shown in FIG. 1, according to one example embodiment.

FIG. 3 is a flow chart for an AI flow according to one example embodiment.

FIG. 4 is a flow chart illustrating operation 304 as shown in FIG. 3, according to one example embodiment.

FIG. 5 depicts a neural network for performing the learning as described in this disclosure, according to one example embodiment.

FIG. 6 depicts a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to a method for testing servers. The method includes constructing an AI framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database. In some embodiments, the method further includes constructing a user interface for receiving the test task.

Various embodiments described herein are also directed to a computer system for testing servers. The computer system includes one or more processors and one or more memories storing computer instructions. The one or more processors are configured to execute the computer instructions to perform operations including: constructing an AI framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database.

Various embodiments described herein are also directed to a storage medium storing computer instructions for testing servers. The computer instructions, when executed by one or more processors, cause the one or more processors to perform operations including: constructing an AI framework system; packaging a test script for testing the servers and putting the test script into the AI framework system; receiving first test results from the AI framework system and generating a database for storing the first test results; receiving a test task for testing the servers; executing the test task with the AI framework system; and outputting second test results for the test task to the database.

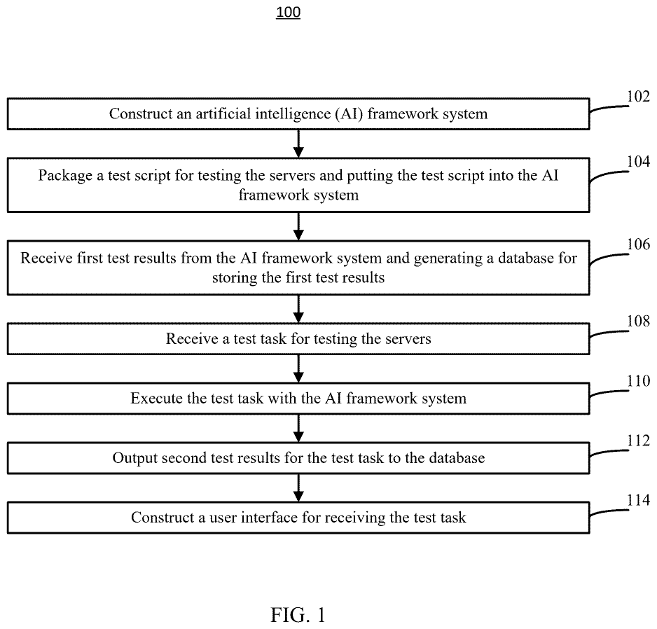

Further embodiments will now be explained with the accompanying figures. Reference is first made to FIG. 1. FIG. 1 is a flow chart illustrating a method 100 for testing servers, according to one example embodiment. The method 100 includes, at 102, constructing an AI framework system. In some embodiments, the AI framework system may be constructed with some existing software systems to reduce time and cost to develop. In one embodiment, the AI framework system may be constructed with open-source software systems such as Jenkins and Docker. The method 100 further includes, at 104, packaging a test script for testing the servers and putting/executing the test script into the AI framework system. In some embodiments, packaging the test script may include packaging the Power/CPU/Memory/BMC stress test script for testing servers and put the script into the system that builds the AI framework environment. The method 100 further includes, at 106, receiving first test results for the test script from the AI framework system and generating a database for storing the first test results. After the test script is executed at the AI framework environment, the results are outputted and stored at a database. In some embodiments, the database may be integrated in the AI framework system to increase the speed for future testing.

The method 100 further includes, at 108, receiving a test task for testing servers. The test task may be triggered by a user manipulating the AI framework system. For example, the AI framework system may include a user interface for the user to interact with and enter test parameters. The method 100 further includes, at 110, executing the test task with the AI framework system. In this operation, the user starts the test through the test interface and starts testing on the server(s). The method 100 further includes, at 112, outputting second test results for the test task to the database.

In some embodiments, the method 100 may further include, at 114, constructing a user interface for receiving the test task at operation 108. The user interface may be designed to trigger and manage test executions for the AI framework, for example, through Jenkins software system, utilizing parameters for flexibility and a Jenkins Pipeline script to run the tests inside Docker containers. The user interface may allow users to input parameters for testing, which are passed to the pipeline, dynamically modifying the test configurations and execution processes.

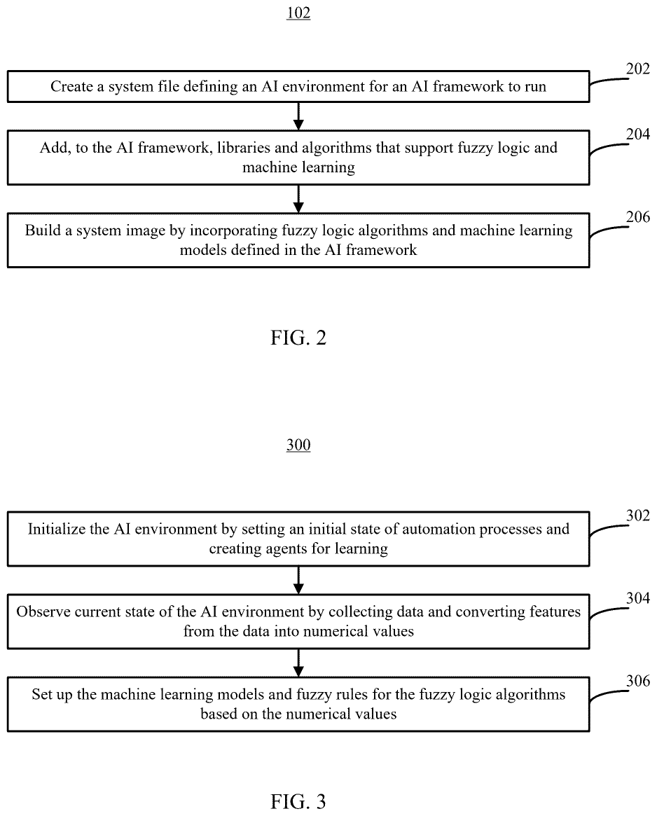

In some embodiments, referring to FIG. 2, the operation 102 may include, at 202, creating a system file defining an AI environment for an AI framework to run. For example, this operation can build Docker Images incorporating fuzzy logic-based algorithms with learning capabilities. One aspect of this operation is to package AI framework and fuzzy logic algorithms into a Docker container, such that it supports learning capabilities for adaptive performance improvement. The operation 102 may further include, at 204, adding, to the AI framework, libraries and algorithms that support fuzzy logic and machine learning. The operation 102 may further include, at 206, building a system image by incorporating fuzzy logic algorithms and machine learning models defined in the AI framework.

In some embodiments, the method 100 may start an AI flow 300 as depicted in FIG. 3. At 302, the AI flow 300 includes initializing the AI environment by setting an initial state of automation processes and creating agents for learning. At 304, the AI flow 300 further includes observing current state of the AI environment by collecting data and converting features from the data into numerical values. At 306, the AI flow 300 further includes setting up the machine learning models and fuzzy rules for the fuzzy logic algorithms based on the numerical values.

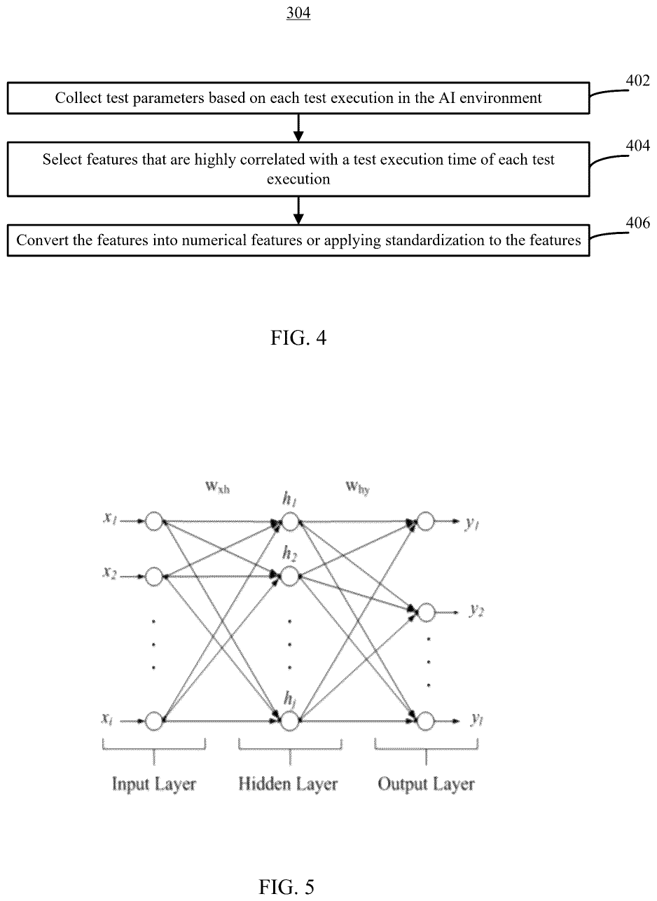

In some embodiments, referring to FIG. 4, the operation 304 may include, at 402, collecting test parameters based on each test execution in the AI environment. For example, the test parameters may include one or more of a type of each test, a number of test cycles, configurations of the servers, and a test time of each test. All types of test for servers are contemplated. Example types of tests may include power on/off tests, stress tests, functional tests, etc. Different tests have varying behaviors and time consumption patterns that may be useful for determining whether a server under test is functioning properly. Further, the same test may be performed for several times to ensure the test consistency. A number of the test cycles for each test may be recorded. The tests are also performed for different hardware or software setups/configurations for a server as those configurations may influence the behavior and time of the test. The test parameters further include the time it takes for each test. For example, the time it takes for a server to power on and off, which has an impact on the total test duration. One aspect of this invention is to reduce the time it takes to complete each test through the AI framework.

Referring again to FIG. 4, the operation 304 may include, at 404, selecting features that are highly correlated with a test execution time of each test execution. This operation identifies features that affect the test execution time for the AI framework. The operation 304 may further include, at 406, converting the features into numerical features or applying standardization to the features. This operation can convert categorical features into numerical features, or apply standardization for better processing and model efficiency. Example features may include the numbers of power on and off, the time period for power on and off, the number of execution loops/cycles, the configuration types, etc.

In some embodiments, the operation 306 may include combining a fuzzy logic system with a multi-layer neural network (MLNN) to set up fuzzy rules and a machine learning model. The neural network would learn to model relationships between inputs and outputs based on the fuzzy rules, enhancing decision-making capabilities in complex environments for testing servers.

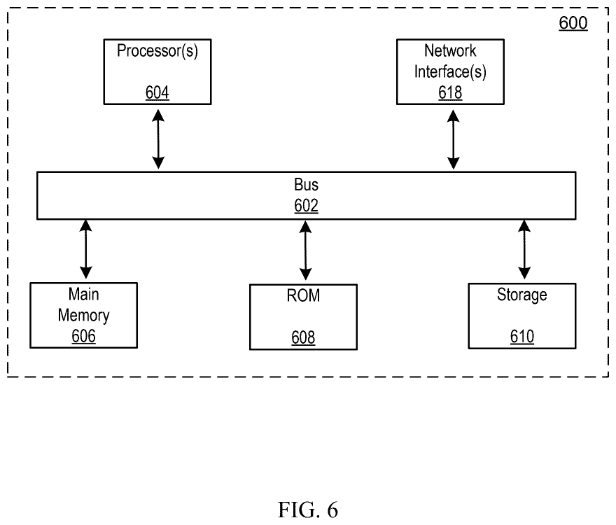

An example neural network 500 for performing the learning as described above is depicted in FIG. 5. The neural network 500 includes m processing elements (PEs) in the input layer, g PEs in the hidden layer, and n PEs in the output layer. The neural network 500 is a three-layer feed-forward neural network. Given an input pattern x, a PE j in the hidden layer receives a net input of

$${net}_{j} = {\sum }_{i = 1}^{m} {h}_{ji} {x}_{i}$$

and produces an output of

$${z}_{j} = a ( {net}_{j} ) = a ( {\sum }_{i = 1}^{m} {h}_{ji} {x}_{i} ) .$$

The net input for a PE i in the output layer can then be expressed as:

$${net}_{l} = {\sum }_{j = 1}^{g} {w}_{lj} {z}_{j} = {\sum }_{j = 1}^{g} {w}_{lj} a ( {\sum }_{i = 1}^{m} {h}_{ji} {x}_{j} ) ,$$

and it produces an output of

$${y}_{l} = a ( {net}_{l} ) = a ( {\sum }_{j = 1}^{g} {w}_{lj} {z}_{j} ) = a ( {\sum }_{j = 1}^{g} {w}_{lj} a ( {\sum }_{i = 1}^{m} {h}_{ji} {x}_{i} ) ) .$$

A transfer function is to do an input weighting value of input of the neuron. The summation is transferred to a mapping rule that is outputted in the function of neural network, and influences a design that is channeled into the non-linear network. The neural network 500 uses a non-linear transfer function, such as a sigmoid function:

$$a = f ( x ) = \frac{1}{1 + {e}^{- x}} .$$

The three-layer feedforward artificial neural network 500 includes one input layer, one hidden layer, and one output layer as shown in FIG. 5. A number of the input nodes is applied to the input layer, and each of the input nodes is defined by a test feature, where all of the inputs are distributed to each unit/node in the hidden layer. The units at the hidden layer have weight vectors which are multiplied by the input vectors. Each unit at the hidden layer sums the inputs and produces a value that is transformed by a nonlinear activation function, such as the sigmoid function. The output of the output layer is then computed by multiplying the output vectors from the hidden layer by the weights into the output layer.

The neural network 500 is operated by defining the input and output variables for testing servers. For example, input variables may include: Number of power on and off (e.g., Low, Medium, High); Each power on and off time (e.g., Short, Medium, Long); Number of execution loops (e.g., Few, Several, Many); Configuration type (e.g., Configuration A, Configuration B, Configuration C). The output variables may include Predict the total test execution time (e.g., Short, Medium, Long), etc.

In some embodiments, based on historical data, the fuzzy rules are designed to describe the relationships between the input variables and the output variables. For example, a fuzzy rule may read “If the number of power on and off is Medium, power on/off time is Long, execution loops is Several and the configuration type is Configuration B, then the total test execution time is Long.” By combining fuzzy logic systems and machine learning models, the disclosed techniques can dynamically predict test execution time based on varying test parameters. These predictions allow for real-time adjustments to the test task/plan, optimizing resource usage and ensuring efficient scheduling, and ultimately enhancing the overall testing process by reducing the time needed for the tests in the future.

Referring back to FIG. 1, the operation 114 may be implemented by integrating Jenkins for continuous integration and continuous delivery, or continuous deployment. Jenkins is first installed in the system and a new Jenkins Pipeline project is created in the Jenkins user interface. In this operation, defining the pipeline script would run the Docker containers to execute the tests.

Once the Al framework is established, a user can run tests on servers through a user interface of the Al framework. For example, the user can select a type of test and the system can automatically perform the test. The test results from those test tasks can be saved in the same database for constructing the AI framework, allowing the AI framework to continue to learn. The system can also automatically send notifications to the user through, for example, email informing the test results. This reduces the user's involvement in the test and improve the efficiency in conducting the test.

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing computer instructions for processor 604. A storage device 610, such as a magnetic disk, optical disk, or USB thumb drive (Flash drive), etc., is provided and coupled to bus 602 for storing information and instructions.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

1. A method for testing servers, comprising:
constructing an artificial intelligence (AI) framework system;
packaging a test script for testing the servers and putting the test script into the AI framework system;
receiving first test results from the AI framework system and generating a database for storing the first test results;
collecting, from the first test results, test parameters associated with prior test executions;
setting up a neural network using the test parameters to predict a test execution metric for a given test task;
receiving a test task for testing the servers;
adjusting execution of the test task based on the predicted test execution metric generated by the neural network;
executing the test task with the AI framework system; and
outputting second test results for the test task to the database.

2. The method of claim 1, further comprising:
constructing a user interface for receiving the test task, and
wherein the test execution metric comprises a test execution time.

3. The method of claim 1, wherein constructing the AI framework system comprises:
creating a system file defining an AI environment for an AI framework to run;
adding, to the AI framework, libraries and algorithms that support fuzzy logic and machine learning; and
building a system image by incorporating fuzzy logic algorithms and machine learning models defined in the AI framework.

4. The method of claim 3, further comprising:
initializing the AI environment by setting an initial state of automation processes and creating agents for learning;
observing current state of the AI environment by collecting data and converting features from the data into numerical values; and
setting up the machine learning models and fuzzy rules for the fuzzy logic algorithms based on the numerical values.

5. The method of claim 4, wherein observing current state of the AI environment by collecting data and converting features from the data into numerical values comprises:
selecting features correlated with a test execution time of each test execution; and
converting the features into numerical features or applying standardization to the features.

6. The method of claim 1, wherein the test parameters comprise one or more of a type of the given test, a number of test cycles, configurations of the servers, and a test time of the given test.

7. The method of claim 4, wherein setting up the machine learning models and fuzzy rules for the fuzzy logic algorithms based on the numerical values comprises:
combining a fuzzy logic system with a multi-layered neural network to set up the machine learning models and the fuzzy rules.

8. A computer system comprising one or more processors and one or more memories storing computer instructions, wherein the one or more processors are configured to execute the computer instructions to perform operations comprising:
constructing an artificial intelligence (AI) framework system;
packaging a test script for testing servers and putting the test script into the AI framework system;
receiving first test results from the AI framework system and generating a database for storing the first test results;
collecting, from the first test results, test parameters associated with prior test executions;
setting up a neural network using the test parameters to predict a test execution metric for a given test task;
receiving a test task for testing the servers;
adjusting execution of the test task based on the predicted test execution metric generated by the neural network;
executing the test task with the AI framework system; and
outputting second test results for the test task to the database.

9. The computer system of claim 8, wherein the operations further comprise:
constructing a user interface for receiving the test task.

10. The computer system of claim 8, wherein constructing the AI framework system comprises:
creating a system file defining an AI environment for an AI framework to run;
adding, to the AI framework, libraries and algorithms that support fuzzy logic and machine learning; and
building a system image by incorporating fuzzy logic algorithms and machine learning models defined in the AI framework.

11. The computer system of claim 10, wherein the operations further comprise:
initializing the AI environment by setting an initial state of automation processes and creating agents for learning;
observing current state of the AI environment by collecting data and converting features from the data into numerical values; and
setting up the machine learning models and fuzzy rules for the fuzzy logic algorithms based on the numerical values.

12. The computer system of claim 11, wherein observing current state of the AI environment by collecting data and converting features from the data into numerical values comprises:
selecting features correlated with a test execution time of each test execution; and
converting the features into numerical features or applying standardization to the features.

13. The computer system of claim 8, wherein the test parameters comprise one or more of a type of the given test task, a number of test cycles, configurations of the servers, and a test time of the given test task.

14. The computer system of claim 11, wherein setting up the machine learning models and fuzzy rules for the fuzzy logic algorithms based on the numerical values comprises:
combining a fuzzy logic system with a multi-layered neural network to set up the machine learning models and the fuzzy rules.

15. A non-transitory computer-readable storage medium storing computer instructions which, when executed by one or more processors, cause the one or more processors to perform operations comprising:
constructing an artificial intelligence (AI) framework system;
packaging a test script for testing servers and putting the test script into the AI framework system;
receiving first test results from the AI framework system and generating a database for storing the first test results;
collecting, from the first test results, test parameters associated with prior test executions;
setting up a neural network using the test parameters to predict a test execution metric for a given test task;
receiving a test task for testing the servers;
adjusting execution of the test task based on the predicted test execution metric generated by the neural network;
executing the test task with the AI framework system; and
outputting second test results for the test task to the database.

16. The non-transitory computer-readable storage medium of claim 15, wherein the operations further comprise:
constructing a user interface for receiving the test task.

17. The non-transitory computer-readable storage medium of claim 15, wherein constructing the AI framework system comprises:
creating a system file defining an AI environment for an AI framework to run;
adding, to the AI framework, libraries and algorithms that support fuzzy logic and machine learning; and
building a system image by incorporating fuzzy logic algorithms and machine learning models defined in the AI framework.

18. The non-transitory computer-readable storage medium of claim 17, wherein the operations further comprise:
initializing the AI environment by setting an initial state of automation processes and creating agents for learning;
observing current state of the AI environment by collecting data and converting features from the data into numerical values; and
setting up the machine learning models and fuzzy rules for the fuzzy logic algorithms based on the numerical values.

19. The non-transitory computer-readable storage medium of claim 18, wherein observing current state of the AI environment by collecting data and converting features from the data into numerical values comprises:
selecting features correlated with a test execution time of each test execution; and
converting the features into numerical features or applying standardization to the features.

20. The non-transitory computer-readable storage medium of claim 15, wherein the test parameters comprise one or more of a type of the given test task, a number of test cycles, configurations of the servers, and a test time of the given test task.
